(19) United States
(12) Patent Application Publication
(10) Pub. No.: US 2021/0148168 A1
(43) Pub. Date: May 20, 2021

(54) LADDER WITH TREAD SYSTEM

(71) Applicant: DOREL HOME FURNISHINGS, INC., Wright City, MO (US)

(72) Inventor: Troy FRANKS, Carmel, IN (US)

(21) Appl. No.: 16/070,011

(22) PCT Filed: Feb. 6, 2018
(86) PCT No.: PCT/US2018/017031

§ 371 Date: Jul. 13, 2018

Related U.S. Application Data
(60) Provisional application No. 62/455,803, filed on Feb. 7, 2017.

(51) Int. Cl. E06C 1/32; E06C 7/08

(52) U.S. Cl. CPC E06C 1/32; E06C 7/08

(57) ABSTRACT

A reconfigurable ladder includes a first ladder section and a second ladder section each having several steps. The first and second ladder sections are coupled to one another by a hinge that mounts the second ladder section to the first ladder section for movement about an axis such that the ladder can be reconfigured to FOLDED, UNFOLDED, and FULL-EXTENSION modes.

### PRIORITY CLAIM

This application claims priority to U.S. Provisional Application Ser. No. 62/455,803, filed Feb. 7, 2017, which is expressly incorporated by reference herein.

### BACKGROUND

The present disclosure relates to ladders and steps for ladders, more particularly, the present disclosure relates to steps for center-fold or multi-fold ladders.

### SUMMARY

According to the present disclosure, a ladder includes several steps. In illustrative embodiments, the ladder includes first and second ladder sections and hinges for mounting the second ladder section to the first ladder section for pivotable movement about a horizontal leg-pivot axis among several positions so that a user can pivot the ladder sections about the horizontal leg-pivot axis to establish FOLDED, UNFOLDED, and FULL-EXTENSION modes of the ladder.

In illustrative embodiments, each ladder section includes two laterally spaced-apart and aligned step-support legs and a series of steps. The steps are arranged to interconnect the aligned step-support legs and lie in vertically spaced-apart relation to one another. Each step has a triangle-shaped cross-section to provide three horizontally extending and outwardly facing exterior step surfaces.

In illustrative embodiments, the first and second exterior step surfaces of each step have tread patterns and are configured so that the tread patterns will be stepped on by a user when the ladder is in either the UNFOLDED or FULL-EXTENSION modes. The third exterior step surface is smooth and the step is coupled to the aligned step-support legs to orient the third step exterior surface so that it will not be stepped on by a user when the ladder is in either the UNFOLDED or FULL-EXTENSION modes.

In illustrative embodiments, each of the ladder sections has a front side and a rear side. When the ladder is used in the FOLDED mode, the front sides of the first and second ladder sections face outwardly away from one another and the rear sides face inwardly toward one another. When the ladder is used in the FULL-EXTENSION mode, each of the front sides face outwardly in the same direction toward a user about to climb the ladder.

In illustrative embodiments, in the first ladder section, the steps are oriented to cause the first exterior step surface to face upwardly and the second exterior step surface to face forwardly toward a user standing on one side of the ladder facing the first ladder section. In the second ladder section, the steps are oriented to cause the first exterior step surface to face forwardly toward a user standing on an opposite second side of the ladder and facing the second ladder section and the second exterior step surface to face upwardly. In each ladder section, the third exterior step surfaces are arranged to face rearwardly.

In illustrative embodiments, when the ladder is used in the UNFOLDED mode in which the first and second ladder sections are inclined in oppositely sloping relation to one another, a user will step on the tread patterns of the first exterior step surface of the steps included in the first ladder section when climbing the first ladder section and step on the tread patterns of the second exterior step surface of the steps included in the second ladder section when climbing the second ladder section. However, when the ladder is used in the FULL-EXTENSION mode in which the first and second ladder sections are aligned to lie in end-to-end relation to one another a user that climbs the first ladder section and then the second ladder section in sequence will step on the tread patterns of the first exterior step surfaces of the steps included in both ladder sections.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWING

The detailed description particularly refers to the following figures in which:

FIG. 1 is a perspective view of a ladder in accordance with the present disclosure and showing that the ladder includes hinges for pivotably coupling an upper end of a first ladder section to an upper end of a companion second ladder section;

FIG. 2 is an enlarged perspective view of one of the steps in the ladder showing the step orientation used in the first ladder section in which an upwardly facing first exterior step surface has a first tread pattern, a rearwardly facing second exterior step surface has a second tread pattern, and a forwardly facing third exterior step surface has a smooth pattern;

FIG. 3 is a sectional view of the step of FIG. 2 taken along line 3-3 shown in FIG. 2;

FIG. 4 is a perspective view of the ladder of FIG. 1 in a FOLDED mode in which the ladder is collapsed for storage or transport;

FIG. 5 is another view of the ladder of FIG. 1 in the UNFOLDED mode showing that the tread pattern on the first exterior step surface of each step in the first ladder section faces upwardly and showing that the tread pattern on the second exterior step surface of each step in the second ladder section faces upwardly; and

FIG. 6 is a perspective view of the ladder of FIG. 1 in the FULL-EXTENSION mode showing that the tread pattern on the first exterior step surface of each step in the first and second ladder sections faces upwardly.

### DETAILED DESCRIPTION

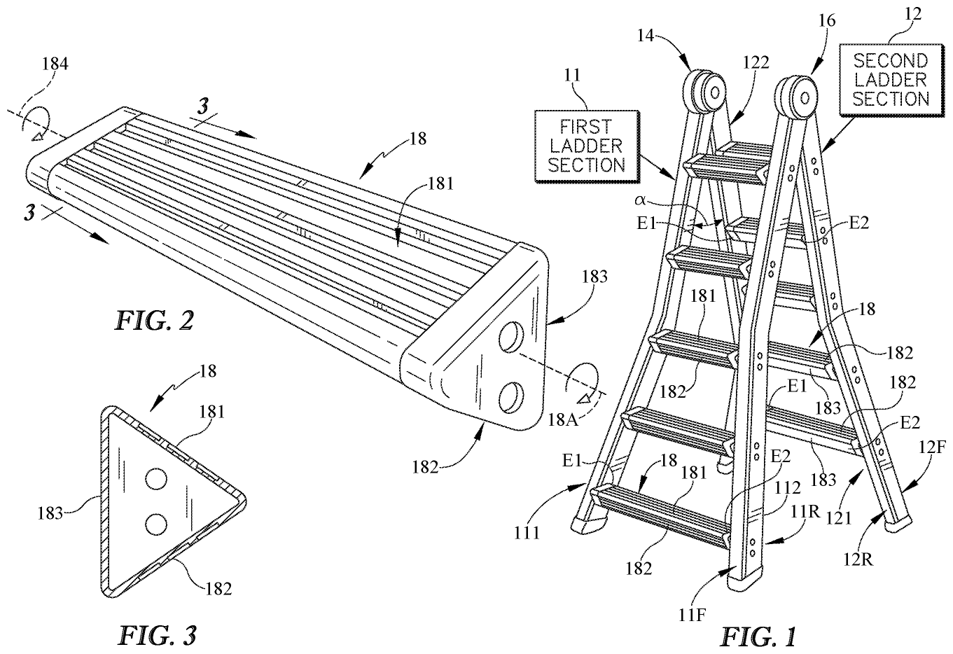

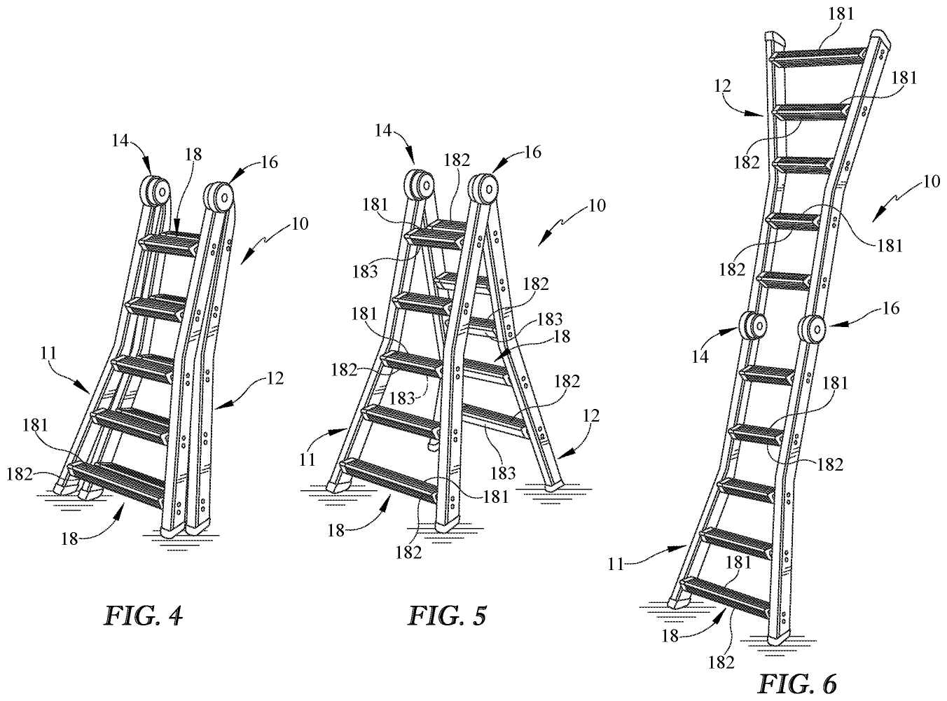

A ladder 10 includes first and second leg sections 11, 12 and a pair of hinges 14, 16 for coupling upper ends of first and second leg sections 11, 12 together as shown in FIG. 1. Hinges 14, 16 support second leg section 12 for pivotable movement about leg-pivot axis 12A from a closed position shown in FIG. 4 and associated with a FOLDED mode of ladder 10 either to (1) a partly opened position shown in FIG. 5 and associated with an UNFOLDED mode of ladder 10 or (2) a fully opened position shown in FIG. 6 and associated with a FULL-EXTENSION mode of ladder 10.

A step 18 having a triangle-shaped cross-section, and three exterior step surfaces 181, 18R, and 183 can be used in both ladder sections 11, 12 of ladder 10 as shown in FIG. 1. In accordance with the present disclosure, steps 18 included in first ladder section 11 are mounted in a stationary positions to have a first orientation about horizontal axis 18A and the steps 18 included in second ladder section 12 are mounted in stationary positions after they have been rotated about 1200 about horizontal axis 18A to assume a second orientation as shown in FIG. 1.

First ladder section 11 includes laterally spaced-apart first and second legs 111, 112 and a series of steps 18. Each step 18 is arranged to mate a first end E1 with first leg 111 and an opposite second end E2 with second leg 112 as shown in FIG. 1. Each step 18 includes a first exterior step surface 181 having a tread pattern, a second exterior step surface 182 having a tread pattern, and a third exterior step surface 183 having a smooth pattern as shown, for example, in FIGS. 2 and 3. Each step 18 in first ladder section 11 is oriented as shown in FIGS. 1 and 5 to cause first exterior step surface 181 to face upwardly, second exterior step surface 182 to face forwardly, and third exterior step surface to face rearwardly. First ladder section 11 has a front side 11F and a rear side 11R as shown in FIG. 1.

Second ladder section 12 includes laterally spaced-apart first and second legs 121, 122 and a series of steps 18. During assembly of the ladder components at a factory, hinge 14 is coupled to upper ends of first leg 111 of first ladder section 11 and second leg 122 of second ladder section 12 while hinge 16 is coupled to upper ends of second leg 112 of first ladder section 11 and first leg 121 of second ladder section 12 as shown in FIG. 1.

Second ladder section 12 also includes a series of steps 18 as shown in FIG. 1. First end E1 of step 18 is coupled to second leg 122 of second ladder section 12. Second end E2 of step 18 is coupled to first leg 121 of second ladder section 12. Steps 18 in second ladder section 12 have been rotated through an angle of about 120 about horizontal rotation axis 18A (as suggested in FIG. 2) from a first orientation associated with steps 18 in first ladder section 11 to assume a second orientation associated with steps 18 in second ladder section 12 as shown, for example, in FIG. 1. Second ladder section 12 has a front side 12F and a rear side 12R as shown in FIG. 1.

In illustrative embodiments, in first ladder section 11, steps 18 are oriented to cause first exterior step surface 181 to face upwardly and second exterior step surface 182 to face forwardly as shown in FIG. 1. In second ladder section 12, steps 18 are oriented to cause first exterior step surface 181 to face forwardly and second exterior step surface 182 to face upwardly. In each ladder section, the third exterior step surfaces 183 are arranged to face rearwardly. When ladder 10 is used in the UNFOLDED mode in which the first and second ladder sections 11, 12 are inclined in oppositely sloping relation to one another to form an acute angle α between the back sides of the first and second ladder sections 11, 12 as shown in FIGS. 1 and 5, a user will step on the tread patterns of the first exterior step surfaces 181 of the steps 18 in the first ladder section 11 when climbing the first ladder section 11 and step on the tread patterns of the second exterior step surfaces 182 of the steps 18 in the second ladder section 12 when climbing the second ladder section 12. In the UNFOLDED mode, the upwardly facing surfaces of steps at the same vertical position may be co-planar with one another. However, when ladder 10 is used in the FULL-EXTENSION mode in which the first and second ladder sections are aligned to lie in end-to-end relation to one another as shown in FIG. 6, a user that climbs the first ladder section 11 and then the second ladder section 12 in sequence will step on the tread patterns of the first exterior step surfaces 181 of the steps 18 in both ladder sections 11, 12.

In the illustrated embodiment, the tread pattern includes a plurality of channels formed in a surface as shown in FIGS. 2 and 3. In other embodiments, the tread pattern may include raised ridges, a number of dimples and/or protrusions, friction strips, or any other suitable structure to create a discontinuity or increased friction zone on the surface so as to promote engagement with a corresponding step.

The following numbered clauses include embodiments that are contemplated and non-limiting:

Clause 1. A reconfigurable ladder comprising

a first ladder section having a front side and a rear side,

a second ladder section having a front side and a rear side, and

a hinge coupled to the first ladder section and the second ladder section, the hinge configured to mount the second ladder section to the first ladder section for pivotable movement about a horizontal leg-pivot axis among several positions so that a user can pivot the ladder sections about the horizontal leg-pivot axis to establish a FOLDED mode of the reconfigurable ladder in which the front sides of the first and second ladder sections face outwardly away from one another and the rear sides face toward one another, an UNFOLDED mode of the reconfigurable ladder in which the first and second ladder sections are inclined in oppositely sloping relation to one another to form an acute angle between the rear sides of the first and second ladder sections, and a FULL-EXTENSION mode of the reconfigurable ladder in which the first and second ladder sections are aligned to lie in end-to-end relation to one another and each of the front sides face in the same direction,

wherein each of the first ladder section and the second ladder section includes two laterally spaced-apart and aligned step-support legs and a series of steps, the steps are arranged to interconnect the aligned step-support legs and lie in vertically spaced-apart relation to one another, and each step has a triangle-shaped cross-section to provide three horizontally extending and outwardly facing exterior step surfaces.

Clause 2. The reconfigurable ladder of any other suitable clause, wherein each step includes a first exterior step surface, a second exterior step surface, and a third exterior step surface, the first exterior step surface and the second exterior step surface have tread patterns, the first exterior step surface and the second exterior step surface and are configured so that the tread patterns will be stepped on by a user when the ladder is in either the UNFOLDED or FULL-EXTENSION modes.

Clause 3. The reconfigurable ladder of any other suitable clause, wherein the third exterior step surface is smooth and each step is coupled to corresponding aligned step-support legs to orient the third step exterior surface so that it will not be stepped on by a user when the ladder is in either the UNFOLDED or FULL-EXTENSION modes.

Clause 4. The reconfigurable ladder of any other suitable clause, wherein, when the second ladder section is in the UNFOLDED mode, (1) the steps of the first ladder section are oriented to cause the first exterior step surface having treads to face upwardly, the second exterior step surface having treads to face forwardly toward a user standing on a first side of the ladder facing the first ladder section, and the third exterior step surface without treads to face rearwardly away from a user standing on the first side of the ladder, and (2) the steps of the second ladder section are oriented to cause the first exterior step surface having treads to face forwardly toward a user standing on a second side of the ladder facing the second ladder section, the second exterior step surface having treads to face upwardly, and the third exterior step surface without treads to face rearwardly away from a user standing on the second side of the ladder.

Clause 5. The reconfigurable ladder of any other suitable clause, wherein, when the ladder is in the FULL-EXTENSION mode, (1) the steps of the first ladder section are oriented to cause the first exterior step surface having treads to face upwardly, the second exterior step surface having treads to face forwardly toward a user standing on the first side of the ladder facing the first ladder section, and the third exterior step surface without treads to face rearwardly away from a user standing on the first side of the ladder, and (2) the steps of the second ladder section are oriented to cause the first exterior step surface having treads to face upwardly, the second exterior step surface having treads to face forwardly toward the user standing on the first side of the ladder facing the second ladder section, and the third exterior step surface without treads to face rearwardly away from a user standing on the first side of the ladder.

1. A reconfigurable ladder comprising
a first ladder section having a front side and a rear side,
a second ladder section having a front side and a rear side, and
a hinge coupled to the first ladder section and the second ladder section, the hinge configured to mount the second ladder section to the first ladder section for pivotable movement about a horizontal leg-pivot axis among several positions so that a user can pivot the ladder sections about the horizontal leg-pivot axis to establish a FOLDED mode of the reconfigurable ladder in which the front sides of the first and second ladder sections face outwardly away from one another and the rear sides face toward one another, an UNFOLDED mode of the reconfigurable ladder in which the first and second ladder sections are inclined in oppositely sloping relation to one another to form an acute angle between the rear sides of the first and second ladder sections, and a FULL-EXTENSION mode of the reconfigurable ladder in which the first and second ladder sections are aligned to lie in end-to-end relation to one another and each of the front sides face in the same direction,
wherein each of the first ladder section and the second ladder section includes two laterally spaced-apart and aligned step-support legs and a series of steps, the steps are arranged to interconnect the aligned step-support legs and lie in vertically spaced-apart relation to one another, and each step has a triangle-shaped cross-section to provide three horizontally extending and outwardly facing exterior step surfaces.

2. The reconfigurable ladder of claim 1, wherein each step includes a first exterior step surface, a second exterior step surface, and a third exterior step surface, the first exterior step surface and the second exterior step surface have tread patterns, the first exterior step surface and the second exterior step surface and are configured so that the tread patterns will be stepped on by a user when the ladder is in either the UNFOLDED or FULL-EXTENSION modes.

3. The reconfigurable ladder of claim 2, wherein the third exterior step surface is smooth and each step is coupled to corresponding aligned step-support legs to orient the third step exterior surface so that it will not be stepped on by a user when the ladder is in either the UNFOLDED or FULL-EXTENSION modes.

4. The reconfigurable ladder of claim 2, wherein, when the second ladder section is in the UNFOLDED mode, (1) the steps of the first ladder section are oriented to cause the first exterior step surface having treads to face upwardly, the second exterior step surface having treads to face forwardly toward a user standing on a first side of the ladder facing the first ladder section, and the third exterior step surface without treads to face rearwardly away from a user standing on the first side of the ladder, and (2) the steps of the second ladder section are oriented to cause the first exterior step surface having treads to face forwardly toward a user standing on a second side of the ladder facing the second ladder section, the second exterior step surface having treads to face upwardly, and the third exterior step surface without treads to face rearwardly away from a user standing on the second side of the ladder.

5. The reconfigurable ladder of claim 4, wherein, when the ladder is in the FULL-EXTENSION mode, (1) the steps of the first ladder section are oriented to cause the first exterior step surface having treads to face upwardly, the second exterior step surface having treads to face forwardly toward a user standing on the first side of the ladder facing the first ladder section, and the third exterior step surface without treads to face rearwardly away from a user standing on the first side of the ladder, and (2) the steps of the second ladder section are oriented to cause the first exterior step surface having treads to face upwardly, the second exterior step surface having treads to face forwardly toward the user standing on the first side of the ladder facing the second ladder section, and the third exterior step surface without treads to face rearwardly away from a user standing on the first side of the ladder.

6. A reconfigurable ladder comprising
first and second ladder sections, and
a hinge arranged to couple upper ends of the first and second ladder sections together to support the second ladder section for pivotable movement relative to the first ladder section about a leg-pivot axis from a closed position adjacent to the first ladder section and associated with a folded mode of the ladder first through an acute angle to arrive at a partly opened position associated with an unfolded mode of the ladder and second through an obtuse angle to arrive at a fully opened position associated with a full-extension mode of the ladder,
wherein each ladder section includes laterally spaced-apart first and second legs and a series of steps arranged in stationary positions to interconnect the laterally spaced-apart first and second legs, each step is arranged to mate a first end thereof with a companion first leg and an opposite second end thereof with a companion second leg, each step has a first exterior surface having a step-tread pattern, a second exterior surface having a step-tread pattern, and a third exterior surface having a smooth pattern, and the steps are oriented relative to each companion ladder section so that the step-tread patterns will be stepped on by a user when the ladder is in either the unfolded or full-extension modes.

7. The reconfigurable ladder of claim 6, wherein each step has a triangle-shaped cross-section to form a 60 degree included angle between each of the first and second exterior surfaces, the second and third exterior surfaces, and the third and first exterior surfaces.

8. The reconfigurable ladder of claim 7, wherein the steps included in the first ladder section are mounted in stationary positions on the first and second legs of the first ladder section to have a first orientation about a horizontal axis in which the first exterior surface faces upwardly and the steps included in the second ladder section are mounted in stationary positions on the first and second legs of the second ladder section following rotation from the first orientation through an angle of about 120 degrees about the horizontal axis to assume a second orientation.

9. The reconfigurable ladder of claim 8, wherein each step in the first ladder section is oriented to cause the step-tread pattern of the first exterior surface to face upwardly, the step-tread pattern of the second exterior surface to face forwardly away from the second ladder section when the ladder is in the folded mode, and the smooth pattern of the third exterior surface to face rearwardly toward the second ladder section when the ladder is in the folded mode, and wherein each step in the second ladder section is oriented to cause the step-tread pattern of the first exterior surface to face forwardly away from the first ladder section when the ladder is in the folded mode, the step-tread pattern of the second exterior surface to face upwardly, and the smooth pattern of the third exterior surface to face rearwardly toward the first ladder section when the ladder is in the folded mode.

10. The reconfigurable ladder of claim 6, wherein each step in the first ladder section is oriented to cause the step-tread pattern of the first exterior surface to face upwardly, the step-tread pattern of the second exterior surface to face forwardly away from the second ladder section when the ladder is in the folded mode, and the smooth pattern of the third exterior surface to face rearwardly toward the second ladder section when the ladder is in the folded mode, and wherein each step in the second ladder section is oriented to cause the step-tread pattern of the first exterior step surface to face forwardly away from the first ladder section when the ladder is in the folded mode, the step-tread pattern of the second exterior step surface to face upwardly, and the smooth pattern of the third exterior step surface to face rearwardly toward the first ladder section when the ladder is in the folded mode.

11. The reconfigurable ladder of claim 6, wherein the first and second ladder sections are inclined in oppositely sloping relation to one another to form an acute included angle therebetween to cause the step-tread pattern of the first exterior surface of steps in the first ladder section and the step-tread pattern of the second exterior surface of steps in the second ladder section to face upwardly to engage feet of a user standing on steps of the first and second ladder sections when the ladder is in the unfolded mode and the first and second ladder sections are aligned to lie in end-to-end relation to one another when the ladder is in the full-extension mode to cause the step-tread pattern of the first exterior surface of steps in the first ladder section to face upwardly to engage feet of a user standing on the steps of the first ladder section and to cause the step-tread pattern of the second exterior surface of steps in the second ladder section to face upwardly to engage feet of a user standing on the steps of the second ladder section and to cause the smooth pattern of the steps in the first and second ladder sections to face downwardly away from a user standing on steps in the first and second ladder sections.

12. The reconfigurable ladder of claim 11, wherein each step stationary step has a triangle-shaped cross-section to form a 60 degree included angle between each of the first and second exterior surfaces, the second and third exterior surfaces, and the third and first exterior surfaces.

13. The reconfigurable ladder of claim 11, wherein the steps included in the first ladder section are mounted in stationary positions on the first and second legs of the first ladder section to have a first orientation about a horizontal axis in which the step-tread pattern of the first exterior surface faces upwardly and the steps included in the second ladder section are mounted in stationary positions on the first and second legs of the second ladder section following rotation from the first orientation through an angle of about 120 degrees about the horizontal axis to assume a second orientation.

14. A reconfigurable ladder comprising
first and second ladder sections,
hinges for mounting the second ladder section to the first ladder section for pivotable movement about a horizontal leg-pivot axis among several positions so that a user can pivot the ladder sections relative to one another about the horizontal leg-pivot axis to establish discrete folded, unfolded, and fuel-extension modes of the ladder, and wherein
each ladder section includes two laterally spaced-apart and aligned step-support legs and a series of steps arranged to interconnect the aligned step-support legs and lie in vertically spaced-apart relation to one another, each step has a triangle-shaped cross-section to provide three horizontally extending and outwardly facing exterior surfaces, the first and second exterior surfaces of each step have step-tread patterns and are configured so that the step-tread patterns will be stepped on by a user when the ladder is in either the unfolded or full-extension mode, and the third exterior surface has a smooth pattern, each step is coupled to the aligned step-support legs to orient the smooth pattern of the third exterior surface so that it will not be stepped on by a user when the ladder is in either the unfolded or full-extension modes.

15. The reconfigurable ladder of claim 14, wherein each of the ladder sections has a front side and a rear side, the front sides of the first and second ladder sections face outwardly away from one another and the rear sides of the first and second ladder sections face inwardly toward one another when the ladder is in the folded mode, the front sides of each of the first and second ladder sections face outwardly in the same direction toward a user about to climb the ladder when the ladder is in full extension mode, the steps in the first ladder section are oriented to cause the step-tread pattern of the first exterior surface to face upwardly, the step-tread pattern of the second exterior surface to face forwardly toward a user standing on one side of the ladder facing the front side of the first ladder section, and the smooth pattern of the third exterior surface to face rearwardly toward the second ladder section when the ladder is in the folded and unfolded modes, and the steps in the second ladder section are oriented to cause the step-tread pattern of the first exterior surface to face forwardly toward a user standing on an opposite side of the ladder facing the front side of the second ladder section, the step-tread pattern of the second exterior surface to face upwardly, and the smooth pattern of the third exterior surface to face rearwardly toward the first ladder section when the ladder is in the folded and unfolded modes.

16. The reconfigurable ladder of claim 15, wherein the step-tread patterns of the first exterior surface of the steps included in the first ladder section and the step-tread patterns of the second exterior surface of the steps included in the second ladder section face upwardly and the smooth pattern of the third exterior surface of the steps included in the first and second ladder sections face rearwardly when the ladder is in the full-extension mode in which the first and second ladder sections are aligned in end-to-end relation to one another so that a user that climbs the first ladder section and then the second ladder section in sequence will step on the step-tread patterns of the first exterior surfaces of the steps included in the first ladder section and then on the step-tread patterns of the second exterior surfaces of the steps included in the second ladder section.
